(19) United States
(12) Patent Application Publication
(10) Pub. No.: US 2010/0060955 A1
(43) Pub. Date: Mar. 11, 2010

(54) System for scanning and capturing an image on a curved surface

(76) Inventor: Joseph R. Saliba, Orleans, MA (US)

Correspondence Address: Iandiorio Teska & Coleman, 260 Bear Hill Road, Waltham, MA, 02451-1018, US

(21) Appl. No.: 12/231,717

(22) Filed: Sep. 5, 2008

(51) Int. Cl. H04N 1/04

(52) U.S. Cl. 358/493

(57) ABSTRACT

A system for scanning and capturing an image on a curved surface including a housing, a support device including a plurality of rotating shafts for supporting the curved surface, a scanning subsystem including drive system for rotating at least one of the plurality of shafts such that the curved surface is rotated at a predetermined rate and a scanning head proximate the curved surface configured to scan and capture a raw image of the curved surface, and a computer subsystem responsive to the scanning subsystem is configured to extract and store the image from the raw image.

### FIELD OF THE INVENTION

The subject invention relates to a system for scanning and capturing an image on a curved surface.

### BACKGROUND OF THE INVENTION

Wine enthusiasts, for example, may save bottles of wine they like so that they can take them with them to a wine store to purchase the wine. Often, the wine enthusiast will remove the label, discard the bottle, and take the label to the wine store to purchase the wine. The process of removing the labels requires soaking the wine bottles and/or using various solutions. Such a process is cumbersome, time consuming, and messy.

Additionally, wine enthusiasts may order a bottle of wine at a restaurant and discover they enjoyed that wine. As such, the wine enthusiast will often request the waiter to either hand write the relevant information related to the bottle of wine or ask the waiter to remove the wine label so that the wine can later be purchased.

Wine tasting sessions, where retailers present various wines to clientele, often require the labels of the wines presented at the session to be removed and placed on display next to the bottle of wine.

Wine clubs, wherein the participants each bring a unique bottle of wine, often result in the various members finding wines they like. Similarly, when the participants of the wine club find a wine they like, the relevant information on the label must be written down or the label removed.

Electronic scanning has been utilized for many years. To date, its primary use has been for scanning of paper documents, photographs, and the like, which appear on a flat surface, e.g., a piece of paper. However, such technology has not been developed to scan curved surfaces, such as a wine bottle, and the like, to capture the relevant information on the label.

### BRIEF SUMMARY OF THE INVENTION

It is therefore an object of this invention to provide a system for scanning and capturing an image on a curved surface.

It is a further object of this invention to provide such a system which can easily provide information about an image or a label on a curved surface.

It is a further object of this invention to provide such a system which can store a captured image or label on the curved surface in a database.

It is a further object of this invention to provide such a system which enables a user to email the captured image or label on the curved surface.

It is a further object of this invention to provide such a system which enables a user to post the captured image or label on the curved surface on a website.

It is a further object of this invention to provide such a system which is easy to use.

It is a further object of this invention to provide such a system which saves time.

It is a further object of this invention to provide such a system which reduces mess.

It is a further object of this invention to provide such a system which can scan and capture a label on a wine bottle.

It is a further object of this invention to provide such a system which eliminates the need to remove a label from a curved surface.

It is a further object of this invention to provide such a system which eliminates the need to remove a label from a wine bottle.

It is a further object of this invention to provide such a system which quickly and easily provides information about the label on a bottle of wine.

It is a further object of this invention to provide such a system which improves the ability to exchange wine labels at a wine tasting session.

It is a further object of this invention to provide such a system which improves the ability to exchange wine labels at a wine club.

This invention features a system for scanning and capturing a label on a curved surface including a housing, a support device including a plurality of rotating shafts for supporting the curved surface, a scanning subsystem including a drive system for rotating at least one of the plurality of shafts such that the curved surface is rotated at a predetermined rate and a scanning head proximate the curved surface configured to scan and capture a raw image of the curved surface, and a computer subsystem responsive to the scanning subsystem is configured to extract and store the image from the raw image on the curved surface.

In one embodiment, the image on the curved surface may include a label. The image on the curved surface may be on a container. The image on the curved surface may be on a solid object. The image on the curved surface may be on a container and/or a solid object chosen from the group consisting of: a wine bottle, a beer bottle, a liquor bottle, a drug prescription container, and a jam/jelly jar. The drive system may include a stepper motor. The computer subsystem may include one or more ports for providing a connection to a personal computer. The one or more ports may include a universal serial bus (USB) port. The computer subsystem may include scanning electronics and one or more processors. The predetermined rate may be about one revolution of the curved surface per second. The curved surface may be convex shaped. The curved surface may be concave shaped. The computer subsystem may include a database for storing one or more captured labels.

This invention also features a system for scanning and capturing a label on a wine bottle including a housing, a support device including a plurality of rotating shafts for supporting the wine bottle, a scanning subsystem including a drive system for rotating at least one of the plurality of shafts such that the wine bottle is rotated at a predetermined rate and a scanning head proximate the wine bottle configured to scan and capture a raw image of the wine bottle proximate the label, and a computer subsystem responsive to the scanning subsystem configured to extract and store the label from the raw image.

This invention further features a system for scanning and capturing a label on a beverage container including a housing, a support device including a plurality of rotating shafts for supporting the beverage container, a scanning subsystem including a drive system for rotating at least one of the plurality of shafts such that the beverage container is rotated at a predetermined rate and a scanning head proximate the beverage container configured to scan and capture a raw image of the beverage container proximate the label, and a computer subsystem responsive to the scanning subsystem configured to extract and store the label from the raw image.

This invention also features a system for scanning and capturing a label on a curved surface including a housing, a support device including a plurality of rotating shafts for supporting the curved surface, a scanning subsystem including a drive system for rotating at least one of the plurality of shafts such that the curved surface is rotated at a predetermined rate and a scanning head proximate the curved surface configured to scan and capture a raw image of the curved surface proximate the label, and a computer subsystem responsive to the scanning subsystem is configured to extract and store the label from the raw image.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional side-view of one embodiment of the system for scanning and capturing an image on a curved surface of this invention;

FIG. 2 is a perspective top-view of the system shown in FIG. 1;

FIG. 3 is a three-dimensional side-view showing in further detail the curved surface placed proximate the scanning head shown in FIG. 2;

FIG. 4 is a block diagram showing one example of the extraction engine used to extract a label from a raw scanned image of the curved surface shown in FIGS. 1 and 3;

FIG. 5A is a screen shot showing one exemplary operation of a computer subsystem shown in FIG. 1 used to capture and store the label on the curved surface of a wine bottle;

FIG. 5B is a screen shot showing the continuation of the operation shown in FIG. 5A;

FIG. 6 is a screen shot showing one example of a label report generated by the computer subsystem shown in FIGS. 5A-5B;

FIG. 7 is a screen shot showing one example of a drop-down box used to print the label report shown in FIG. 6;

FIG. 8 is a scan shot showing one example of a drop-down box used to email the extracted label report shown in FIG. 6;

FIG. 9 shows one example of a convex surface which may be scanned and captured in accordance with this invention; and

FIG. 10 shows one example of a concave surface which may be scanned and captured in accordance with this invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

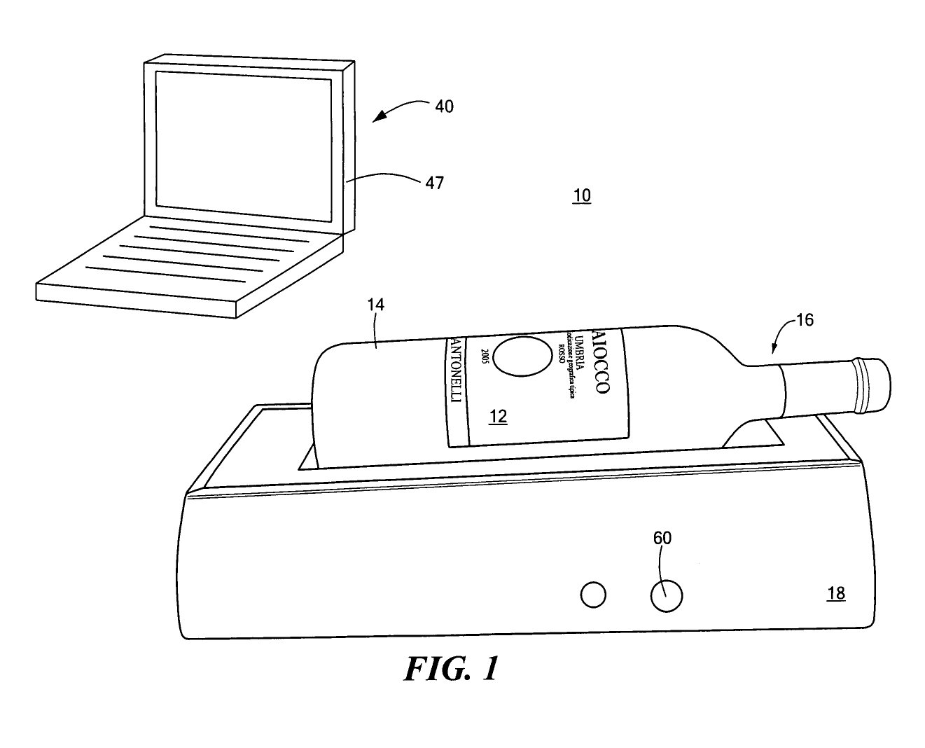

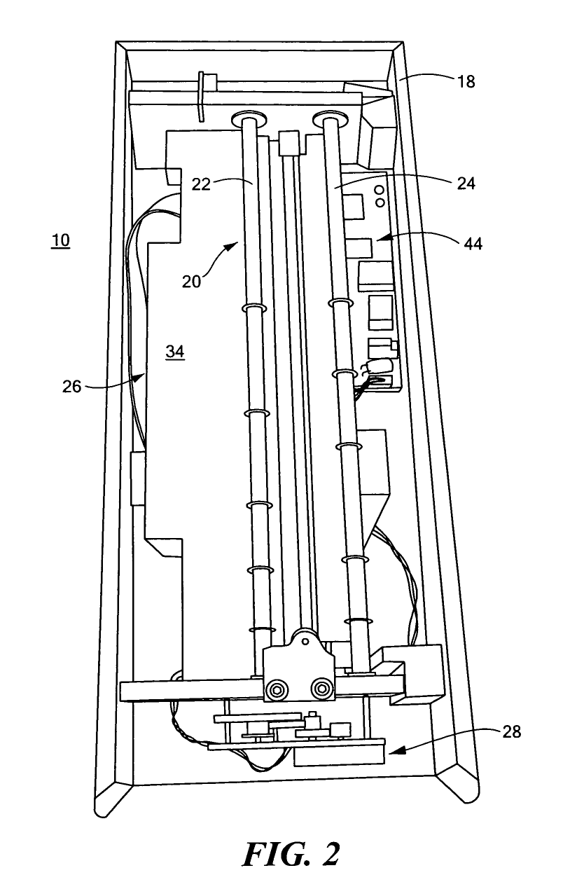

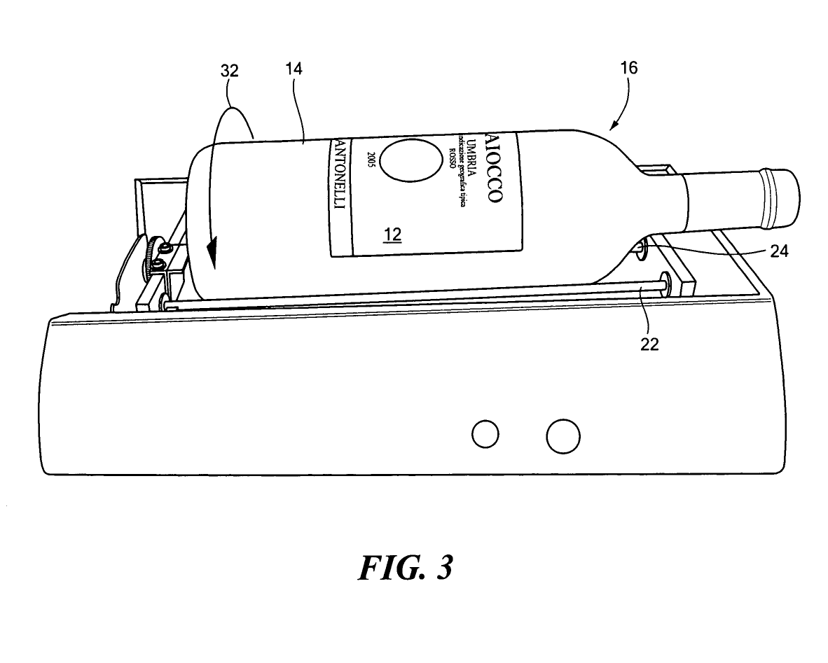

There is shown in FIG. 1 one embodiment of system 10 for scanning and capturing image 12 on curved surface 14. In this example, curved surface 14 is on wine bottle 16 and image 12 is a label on curved surface 14. System 10 includes housing 18 and support device 20, FIG. 2. Support device 20 includes rotating shafts 22 and 24 disposed in housing 18 which support curved surface 14, as shown in FIG. 3. System 10, FIG. 2, also includes scanning subsystem 26 with scanning head 34. Scanning subsystem 26 further includes drive system 28, e.g., a stepper motor or similar type device, that rotates one of shafts 22 and 24, e.g., rotating shaft 22, such that curved surface 14, FIG. 3, e.g., wine bottle 16, is rotated at a predetermined rate in a predetermined direction, e.g., one revolution per second the direction, indicated by arrow 32. Scanning head 34, FIG. 2, is placed proximate to curved surface 14, as shown in FIG. 3 and scans and captures an image of curved surface 14 with image or label 12 thereon as it is rotated. Computer subsystem 40, FIG. 1, e.g., a personal computer 42 with scanning electronics 44, FIG. 2, is responsive to scanning subsystem 26 and extracts and stores image or label 12, FIGS. 1 and 3, on curved surface 14, as discussed below. Computer subsystem 40, FIG. 1, may include one or more ports, e.g., port 60, for providing a connection to a computer such as personal computer 42, or a personal computer (not shown). Typically, port 60 is a universal serial bus port (USB). Scanning subsystem 26 also includes one or more processors located on scanning electronics 44, as known by those skilled in the art.

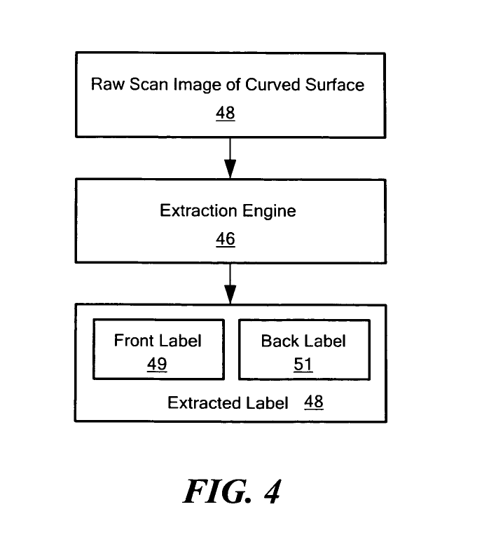

Computer subsystem 40 typically includes supplementary computer software, e.g., extraction engine 46, FIG. 4, which inputs raw scanned image 48 of curved surface 14, FIG. 1, having image or label 12 thereon. Extraction engine 46, FIG. 4, outputs extracted image or label 48, which preferably includes front image or label 49 and back image or label 51, as discussed below.

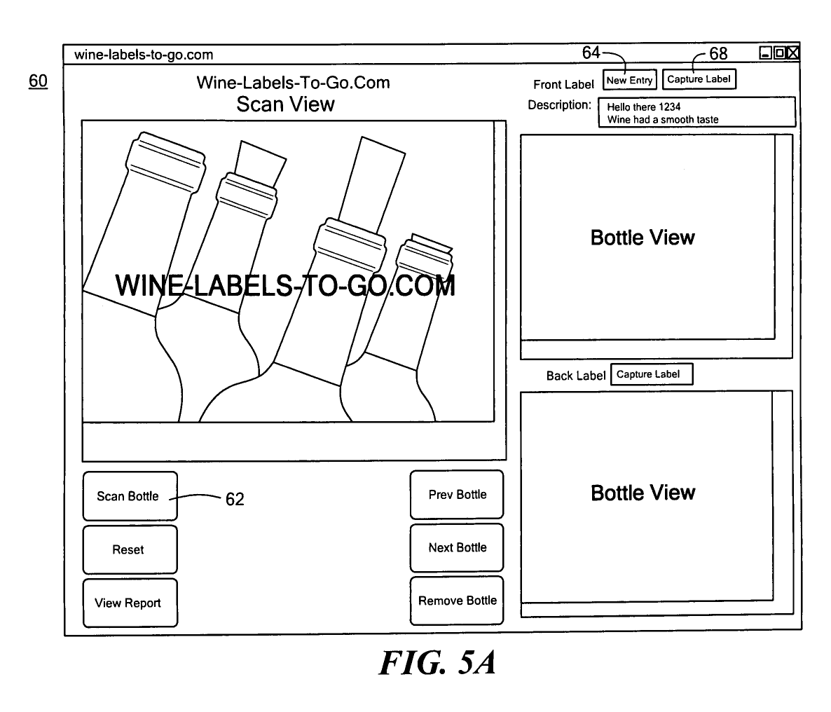

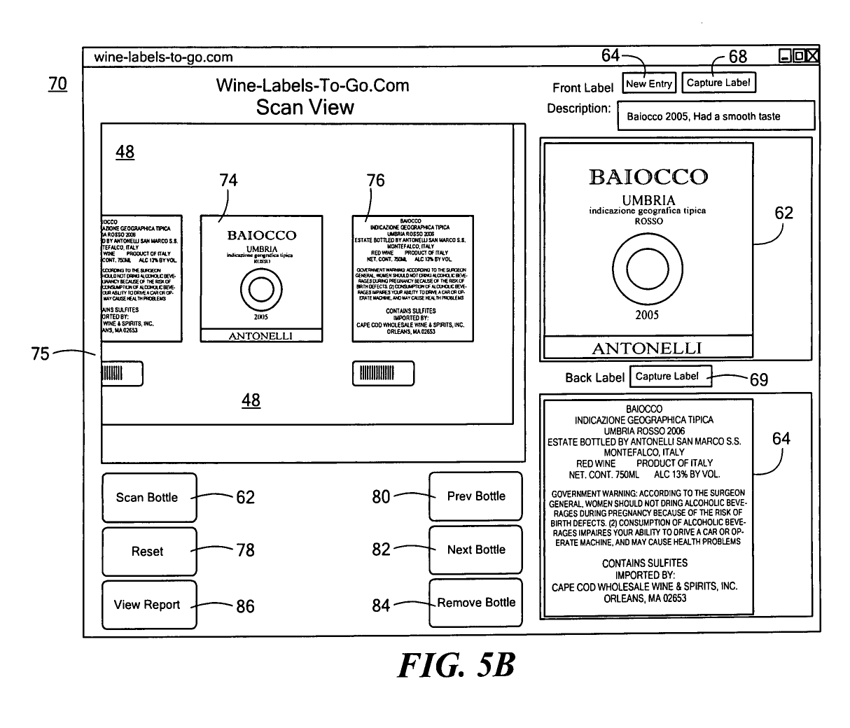

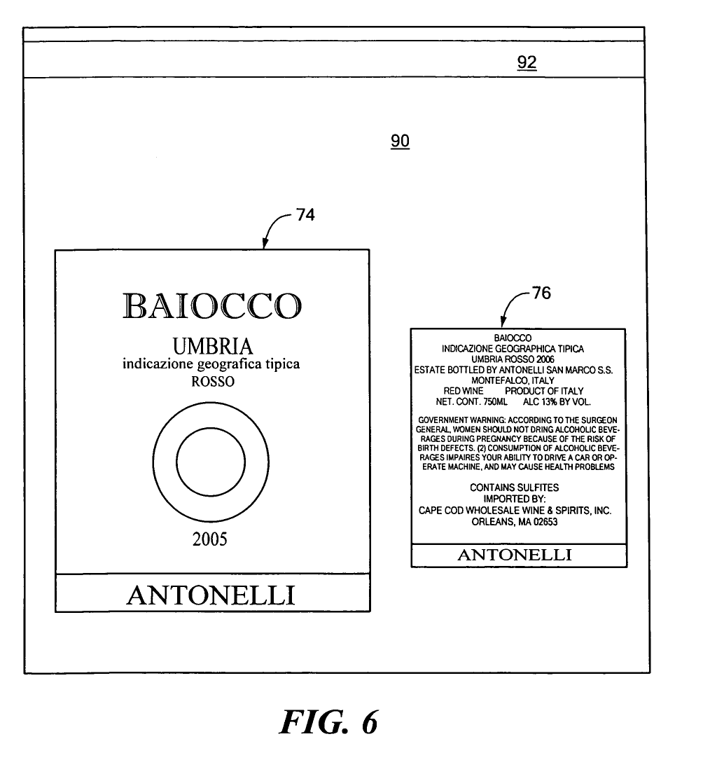

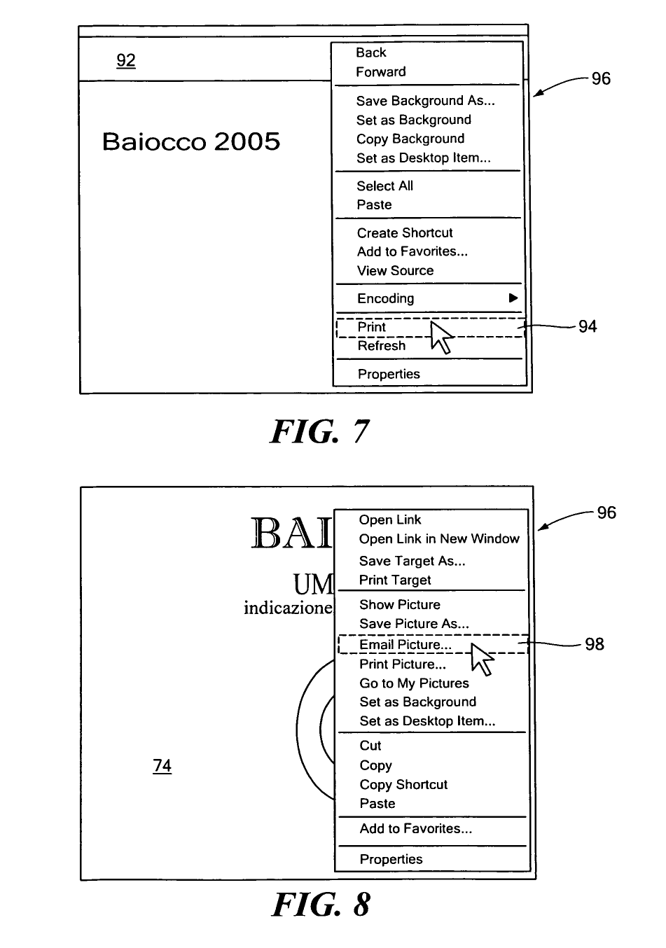

One exemplary operation of system 10 is discussed below with reference to FIGS. 1-5B. To begin the process, a user places wine bottle 16, FIG. 1, having curved surface 14 with image 12 thereon to be scanned and captured on rotating shafts 22 and 24, FIG. 3, disposed in housing 18. In this example, image 12 is a wide label. Using a personal computer 42, FIG. 1, the user activates extraction engine 46, FIG. 4, to initiate view 60, FIG. 5A. The user then hits scan bottle button 62 which causes drive system 28, FIG. 2, to rotate curved surface 14 of wine bottle 16 having label 12 thereon, as discussed above. The user then hits new entry button 64 which allows the user to enter a description relevant to bottle of wine 16 in description box 66, e.g., the “wine had a smooth taste”. Extraction engine 46, FIG. 4, then generates view 70, FIG. 5B, which shows raw scanned image 48 of curved surface 14 and label 12 in window 75. The user then crops front label 74 by using a mouse to outline around front label 74. The user then hits Capture Label button 68 which causes extraction engine 48 to crop front label 74 and display it in window 62. The process is repeated for back label 76 by using Capture Label button 69. The captured back label 76 appears in window 64. Note that if a user tries to crop an incomplete image, the user will get a magnified image and return to the original scan. In this event, the user hits Reset button 78 which allows system 10 to rescan the wine bottle. To navigate through different bottles which have been scanned, or to create a new scan of a new bottle, the user may hit Prev Bottle button 80 or Next Bottle button 82. To remove the bottle 16 from the frame, the user hits Remove Bottle button 84. To position a set of captured labels for emailing or printing, the user hits View Report button 86. FIG. 6 shows an example of report 90 which includes the front label 74 and back label 76. To print a label report, the user right-clicks on red band 92, and selects print 94 from drop-down box 96, FIG. 7. To email front label 74, the user right-clicks on red band 92, FIG. 7, and selects the Email Picture 98, FIG. 8, from drop-down box 96. The process is repeated to email back label 76. The user may also post front label 74 and/or back label 76 on a website, as known by those skilled in the art.

Although as discussed above with reference to FIGS. 1-9, curved surface 14 and image or label 12 were shown on wine bottle 16, this is not a necessary limitation of this invention. In other designs, curved surface 14 and image 12 may be on any type of beverage container, a beer bottle, a liquor bottle, a drug prescription container, or a jam/jelly jar. Image 12 need not necessarily be a separate item affixed to a surface, and may be embossed or engraved on curved surface 14, as known to those skilled in the art.

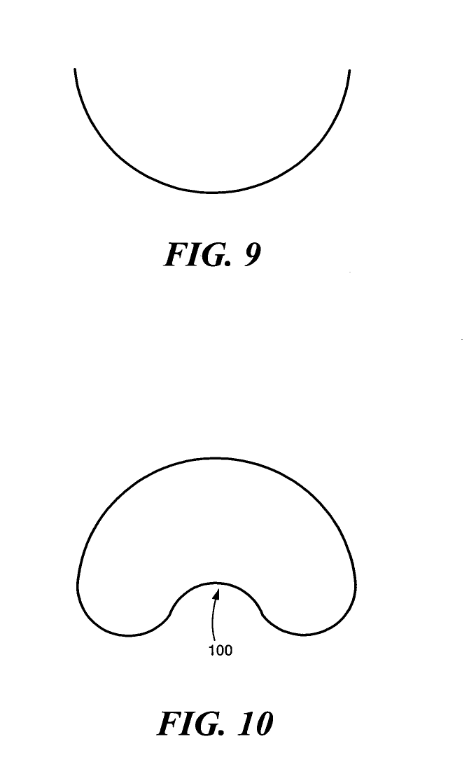

In one design, curved surface 14, FIGS. 1 and 3 may have a concave shaped surface 100, FIG. 9, where like parts have been given like numbers, or concave shaped surface 102, FIG. 10, where like parts have been given like numbers. As shown in FIG. 10, scan head 34 is shown in place below concave shaped surface 102 as are support shafts 22′ and 24′.

The result is system 10 for scanning and capturing an image or a label on a curved surface provides an efficient and easy way to capture and scan images or labels on curved surfaces, such as images or labels on wine bottles, beer bottles, drug prescription containers, jam/jelly jars, and the like. Thus, system 10 eliminates the need to soak the bottles or containers to remove the labels, or write down the relevant information on the label. System 10 also provides a useful service to restaurateurs because they can easily provide a copy of a requested wine label to a patron when the bill is presented. Moreover, those in wine tasting sessions or wine clubs can easily exchange wine labels.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A system for scanning and capturing an image on a curved surface comprising:
a housing;
a support device including a plurality of rotating shafts for supporting the curved surface;
a scanning subsystem including:
a drive system for rotating at least one of the plurality of shafts such that the curved surface is rotated at a predetermined rate, and
a scanning head proximate the curved surface configured to scan and capture a raw image of the curved surface; and
a computer subsystem responsive to the scanning subsystem configured to extract and store the image from the raw image.

2. The system of claim 1 in which the image on the curved surface includes a label.

3. The system of claim 1 in which the image on the curved surface is on a container.

4. The system of claim 3 in which the image on the curved surface is on a solid object.

5. The system of claim 1 in which the image on the curved surface is on a container and/or a solid object chosen from the group consisting of: a wine bottle, a beer bottle, a liquor bottle, a drug prescription container, and a jam/jelly jar.

6. The system of claim 1 in which the drive system includes a stepper motor.

7. The system of claim 1 in which the computer subsystem includes one or more ports for providing a connection to a personal computer.

8. The system of claim 6 in which the one or more ports includes a universal serial bus (USB) port.

9. The system of claim 1 in which the computer subsystem includes scanning electronics and one or more processors.

10. The system of claim 1 in which the predetermined rate is about one revolution of the curved surface per second.

11. The system of claim 1 in which the curved surface is convex shaped.

12. The system of claim 1 in which the curved surface is concave shaped.

13. The system of claim 1 further including a database for storing one or more captured images.

14. A system for scanning and capturing a label on a wine bottle comprising:
a housing;
a support device including a plurality of rotating shafts for supporting the wine bottle;
a scanning subsystem including:
a drive system for rotating at least one of the plurality of shafts such that the wine bottle is rotated at a predetermined rate;
a scanning head proximate the wine bottle configured to scan and capture a raw image of the wine bottle proximate the label; and
a computer subsystem responsive to the scanning subsystem configured to extract and store the label from the raw image.

15. A system for scanning and capturing a label on a beverage container comprising:
a housing;
a support device including a plurality of rotating shafts for supporting the beverage container;
a scanning subsystem including:
a drive system for rotating at least one of the plurality of shafts such that the beverage container is rotated at a predetermined rate, and
a scanning head proximate the beverage container configured to scan and capture a raw image of the beverage container proximate the label; and
a computer subsystem responsive to the scanning subsystem configured to extract and store the label from the raw image.

16. A system for scanning and capturing a label on a curved surface comprising:
a housing;
a support device including a plurality of rotating shafts for supporting the curved surface;
a scanning subsystem including:
a drive system for rotating at least one of the plurality of shafts such that the curved surface is rotated at a predetermined rate, and
a scanning head proximate the curved surface configured to scan and capture a raw image of the curved surface proximate the label; and
a computer subsystem responsive to the scanning subsystem configured to extract and store the label from the raw image.
